(19) United States
(12) Patent Application Publication
(10) Pub. No.: US 2009/0047505 A1
(43) Pub. Date: Feb. 19, 2009

(54) ALUMINUM ALLOY SHELL AND MANUFACTURING METHOD MAKING THE SAME

(75) Inventors: XIAN-LIANG LIU, Shenzhen (CN); FA-HONG ZENG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/955,311

(22) Filed: Dec. 12, 2007

(30) Foreign Application Priority Data
Aug. 17, 2007 (CN) 200710076406.8

(51) Int. Cl. B32B 15/20; C25D 5/44

(52) U.S. Cl. 428/332; 205/205; 428/472.2

(57) ABSTRACT

An aluminum alloy shell (10) and a manufacturing method for making the present aluminum alloy shell are provided. The aluminum alloy shell includes a base shell (11) and a microarc oxidation coating (12). The microarc oxidation coating is formed on a surface of the base shell by micro arc oxidation processing. The manufacturing method includes steps as follows. The base shell is pretreated. The pretreated base shell is microarc oxidized to form the microarc oxidation coating thereon. The aluminum alloy shell is post treated by washing and drying.

### BACKGROUND OF THE INVENTION

1. Field of the Invention

The present invention relates to a shell and a method used to manufacture the shell, particularly to an aluminum alloy shell and a method for making the aluminum alloy shell.

2. Description of Related Art

Generally, an aluminum alloy shell is widely used in an electronic device, especially a portable electronic device, for its lightweight. The aluminum alloy shell typically has a protective layer formed on an exterior surface thereof. The protective layer is used to protect the aluminum alloy shell from being damaged (e.g., being scuffed, or the like).

The protective layer is typically an anodic oxide film, which is formed/deposited on the exterior surface of the aluminum alloy shell during anodic oxidizing process. However, hardness of the anodic oxide film is relatively low. Thus, the cohesive/binding force between the anodic oxide film and the exterior surface is relatively weak. Moreover, capabilities of wear resisting and corrosion resisting are relatively weak. As a result of that, the anodic oxide film tends to depart from the exterior surface and also tends to be abraded or corrosion damaged. The life of the aluminum alloy shell is thus shortened.

Therefore, a heretofore-unaddressed need exists in the art to address the aforementioned deficiencies and inadequacies.

### SUMMARY

In one aspect, an aluminum alloy shell is provided. The aluminum alloy shell includes a base shell and a microarc oxidation coating. The microarc oxidation coating is formed on a surface of the base shell by micro arc oxidation processing.

In another aspect, a manufacturing method for making the present aluminum alloy shell is provided. The manufacturing method includes steps as follows. The base shell is pretreated. The pretreated base shell is microarc oxidized to form the microarc oxidation coating thereon. The aluminum alloy shell is post treated by washing and drying.

These and other aspects of the present invention will become more apparent from the following detailed description of the preferred embodiments taken in conjunction with the accompanying drawings, although variations and modifications therein may be affected without departing from the spirit and scope of the novel concepts of the disclosure.

### BRIEF DESCRIPTION OF THE DRAWINGS

Many aspects of the present aluminum alloy shell and the manufacturing method making the aluminum alloy shell can be better understood with reference to the following drawings. These drawings are not necessarily drawn to scale, the emphasis instead being placed upon clearly illustrating the principles of the present aluminum alloy shell and the manufacturing method making the aluminum alloy shell. Moreover, in the drawings like reference numerals designate corresponding parts throughout the several views. Wherever possible, the same reference numbers are used throughout the drawings to refer to the same or like elements of an embodiment.

FIG. 1 is an isometric view of an aluminum alloy shell in accordance with a present embodiment;

FIG. 2 is a cross-sectional view of the aluminum alloy shell shown in FIG. 1, taken along line II-II;

FIG. 3 is a schematic view of a microarc oxidation device for manufacturing the aluminum alloy shell shown in FIG. 1; and

FIG. 4 is a diagram of a manufacturing method using the microarc oxidation device shown in FIG. 3 for manufacturing the aluminum alloy shell shown in FIG. 1.

### DETAILED DESCRIPTION OF THE EMBODIMENTS

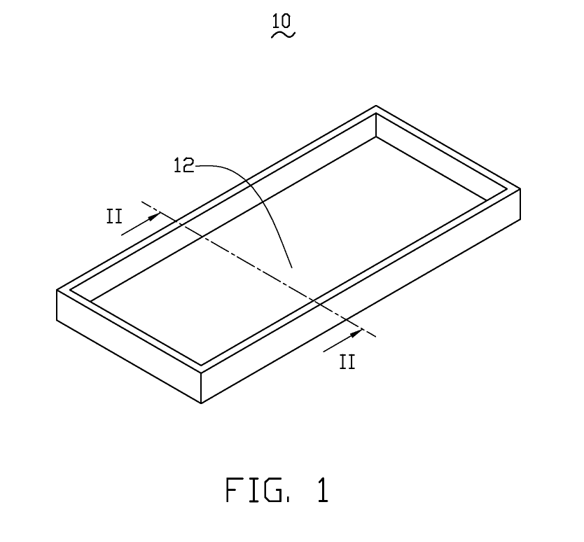

The present aluminum alloy shell and the method for making the aluminum alloy shell is described here in conjunction with the accompanying drawings in FIGS. 1 through 4. The aluminum alloy shell can be incorporated in an electronic device, especially a portable electronic device (e.g., a mobile phone, a personal digital handset, or the like).

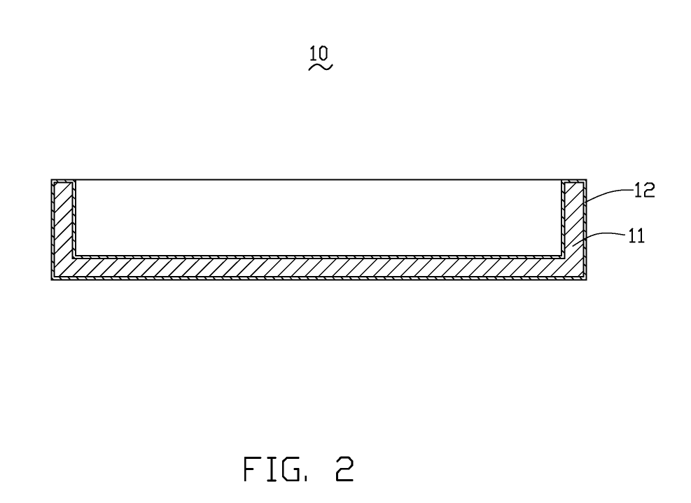

Referring to FIGS. 1 and 2, the aluminum alloy shell 10 includes a base shell 11 and a microarc oxidation coating 12. The microarc oxidation coating 12 is formed/deposited on a surface of the base shell 11 by MAO (Micro Arc Oxidation) processing. The microarc oxidation coating 12 is a ceramic aluminum oxide coating, which has a coating thickness: 8-20 μm.

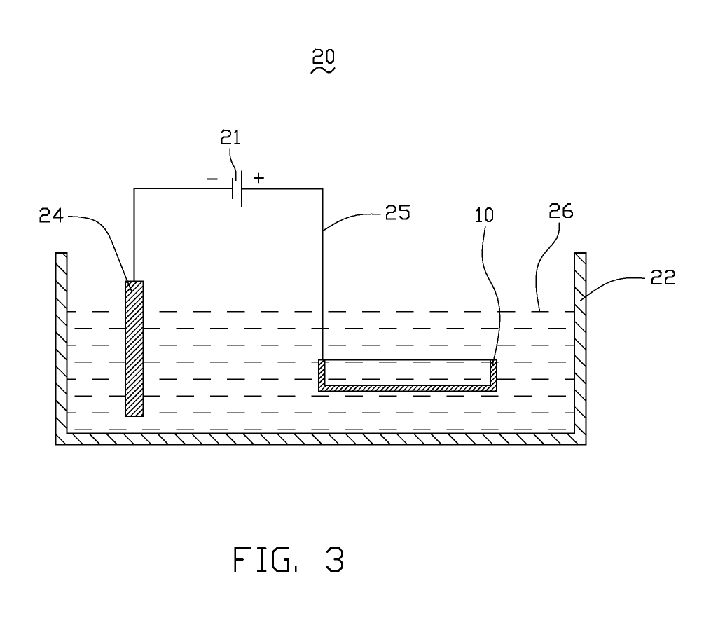

Referring also to FIG. 3, during process of manufacturing the aluminum alloy shell 10 shown in FIGS. 1 and 2, a microarc oxidation device 20 is provided. The microarc oxidation device 20 includes an electrical source 21 with a high electric voltage, an electrolytic bath 22, and an electrode 24. The base shell 11 of the aluminum alloy shell 10 and the electrode 24 respectively electrically connect with the electrical source 21 via two conducting wires 25.

The electrical source 21 can produce voltages of over 200V. These voltages can be continuous DC (Direct Current) voltages or pulsed DC voltages, or alternating pulsed voltages. In this embodiment, the voltages are pulsed DC voltages.

The electrolytic bath 22 usually consists of a dilute alkaline solution 26 such as KOH. In this embodiment, the electrolytic bath 22 consists of a dilute alkaline solution 26 containing sodium hexametahposphate (10 g/l˜20 g/l), sodium silicate (5 g/l˜10 g/l), sodium molybdate (10 g/l˜15 g/l), sodium carbonate (5 g/l˜8 g/l), and sodium tungstate (2 g/l˜5 g/l). The PH (potential of hydrogen) value of the dilute alkaline solution 26 is within a range of 8 to 12.

The base shell 11 of the aluminum alloy shell 10 electrically connects with the electrical source 21 as one of the electrodes (e.g., anode) during MAO process. The electrode 24, being a stainless steel pole, electrically connects with the electrical source 21 for functioning as a counter-electrode (e.g., cathode) during MAO process.

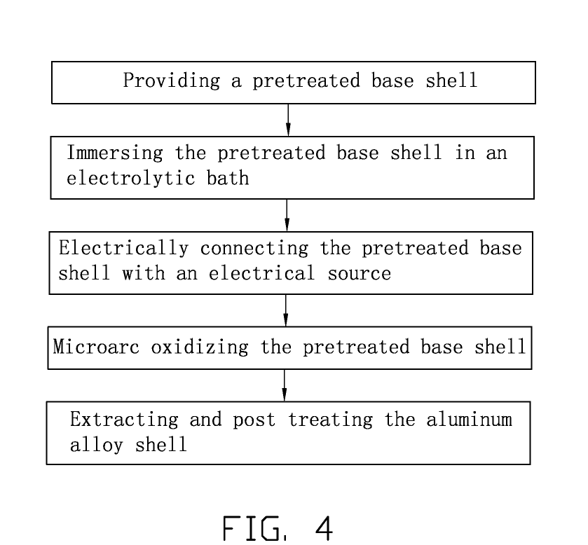

Referring further to FIG. 4, the aluminum alloy shell 10 is manufactured via a set of steps of a method as follows.

First step is to provide the base shell 11 pretreated by degreasing (e.g., using alcohol or acetone) and washing (e.g., using water).

Second step is to immerse the pretreated base shell 11 into the dilute alkaline solution 26 contained in the electrolytic bath 22.

Third step is to electrically connect the pretreated base shell 11 with the electrical source 21.

Fourth step is to microarc oxidize the pretreated base shell 11 so as to deposit the microarc oxidation coating 12 (i.e., aluminum oxide coating) on the surface of the pretreated base shell 11. In this case, the electrical source 21 produces voltages in a range of 50-350V and intensity of pulsed DC in a range of 3-5 A/dm², which are applied to the pretreated base shell 11 and the electrode 24 within the dilute alkaline solution 26 for 10-20 minutes. The microarc oxidation coating 12, with an 8-20 μm thickness, is thus fabricated on the surface of the pretreated base shell 11. The aluminum alloy shell 10 is manufactured.

Fifth step is to extract the aluminum alloy shell 10 from the dilute alkaline solution 26 and then has it post treated by washing (e.g., using water) and drying (e.g., oven drying).

One main advantage of the present embodiment embodies that the microarc oxidation coating 12 obtained by MAO has high adhesion, high Vickers hardness up to 25 Gpa, high erosion/abrasion wear resistance, high thermal shock resistance, and dielectric properties. The base shell 11 of the aluminum alloy shell 10 with the microarc oxidation coating 12 can thus be effectively protected against abrasion, erosion, heat, or thermal shocking as well as electrical insulation.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An aluminum alloy shell, comprising:
a base shell; and
a microarc oxidation coating formed on a surface of the base shell by micro arc oxidation processing.

2. The aluminum alloy shell as claimed in claim 1, wherein thickness of the microarc oxidation coating is 8-20 μm.

3. A manufacturing method for making an aluminum alloy shell, the aluminum alloy shell including a base shell and a microarc oxidation coating, the manufacturing method comprising steps of:
pretreating the base shell;
microarc oxidizing the pretreated base shell to form the microarc oxidation coating thereon; and
post treating the aluminum alloy shell.

4. The manufacturing method as claimed in claim 3, wherein the base shell is pretreated via degreasing and washing.

5. The manufacturing method as claimed in claim 3, wherein during step of microarc oxidizing, a microarc oxidation device is provided, the microarc oxidation device comprises an electrical source with a high electric voltage, an electrolytic bath, and an electrode, and the base shell and the electrode electrically connect with the electrical source.

6. The manufacturing method as claimed in claim 5, wherein the electrical source produces pulsed direct current (DC) voltages.

7. The manufacturing method as claimed in claim 6, wherein the electrical source produces voltages in a range of 50-350V and intensity of pulsed DC in a range of 3-5 A/dm², which are applied to the pretreated base shell and the electrode for 10-20 minutes.

8. The manufacturing method as claimed in claim 5, wherein the electrolytic bath consists of a dilute alkaline solution, and PH value of the dilute alkaline solution is within a range of 8 to 12.

9. The manufacturing method as claimed in claim 8, wherein the dilute alkaline solution contains sodium hexametahposphate (10 g/l˜20 g/l), sodium silicate (5 g/l˜10 g/l), sodium molybdate (10 g/l˜15 g/l), sodium carbonate (5 g/l˜8 g/l), and sodium tungstate (2 g/l˜5 g/l).

10. The manufacturing method as claimed in claim 3, wherein thickness of the microarc oxidation coating is 8-20 μm.
